(19) United States
(12) Patent Application Publication
(10) Pub. No.: US 2005/0283813 A1
(43) Pub. Date: Dec. 22, 2005

(54) Systems and methods for recording signals from communication devices as messages and making the messages available for later access by other communication devices

(75) Inventors: John Jamail, Waltham, MA (US); Matthew Schmitt, Brookline, MA (US)

Correspondence Address: HAHN LOESER & PARKS, LLP, One GOJO Plaza, Suite 300, AKRON, OH, 44311-1076, US

(73) Assignee: STARBAK COMMUNICATIONS, INC., Waltham, MA (US)

(21) Appl. No.: 10/869,839

(22) Filed: Jun. 18, 2004

(51) Int. Cl. H04N 7/173

(52) U.S. Cl. 725/109; 725/106; 725/110

(57) ABSTRACT

This invention relates to systems and methods that allow data to be recorded from communication devices as messages for later viewing through the transmission of audio and digital data streams over a distributed communications network. The invention relates to a method for transmitting a message from a calling device to a remote video mail server and for retrieving the message at a later time over a distributed network including connecting the calling device to the remote video mail server; supplying the message from the calling device to the remote video mail server; storing the message on the remote video mail server; and accessing the message by a communication device from the remote video mail server at a later time.

### BACKGROUND OF THE INVENTION

1. Field of Invention

This invention relates to systems and methods that enable audio and/or video signals to be recorded from communication devices as messages for later access through the transmission of the video and/or audio signals over a distributed communications network.

2. Description of Related Art

Conventional public branch exchange (PBX) systems only have the ability to record and store voice mail messages. These systems achieve this primarily through use of a personal computer (PC) that records or stores the audio as a .WAV or other digital file that is then retrieved when desired by the intended recipient. However, conventional PBX systems can not record or store digital audio and video streams for later retrieval by the intended recipient through the transmission of the video and audio streams over a distributed communications network.

Digital video and audio streams may originate from a number of communication devices which capture images and sounds such as the images and voices of one or more individuals. For example, the digital video and audio streams may originate from communication devices (equipment) for a video conference.

Video conferencing equipment generally comprises a variety of types of equipment, including data stream display and capture equipment, such as cameras, microphones, televisions and speakers; end point devices that connect the data stream and capture equipment of one video conference participant to another end point device or to a multi-point control unit; and the multi-point control unit, which allows three or more end point devices to participate in a single video conference session.

The end point device converts the audio and video signals from the camera, microphone, etc. into data streams transmittable to another end point device or the multi-point control unit. The end point device also converts the audio and video data streams it receives, from another end point device or from the multi-point control unit, into signals usable by the audio and video display devices connected to that end point device.

The multi-point control unit is a conference bridge that connects the various end point devices participating in a single video conference session when more than two end point devices are participating in the video conference. While in general, two end point devices can be connected directly to each other, in practice, most video conference sessions, even when only two participants are involved, are routed through a multi-point control unit. One multi-point control unit can be used for a number of video conference sessions, where each session has two or more participants.

In operation, each of the end point devices contacts the multi-point control unit. After data sufficient for the multi-point control unit to authenticate the participants' authorization to participate in a video conference is provided to that multi-point control unit, the multi-point control unit connects that end point device to the one or more other end point devices, so that the user of that end point device can participate in that video conference session. The multi-point control unit, or a video conference administrator or coordinator, confirms a video conference participants' authorization to participate in the video conference based on the video conference participant supplying a predefined password, or the like.

The end point devices and the multi-point control unit typically communicate using the H.320 or the H.323 standard. The H.320 standard is the standard for ISDN video conferencing. The H.323 standard extends the H.320 ISDN video conferencing standards to a standard usable for Internet protocol (IP)-based distributed networks. The Session Initiation Protocol (SIP) is a third video conferencing protocol. Video conference equipment, which uses the H.323 standard, uses standard Internet protocol (IP) handshake and messaging protocols and data and packet formats that are used on a standard Internet protocol (IP)-based distributed network, such as the Internet, many wide area networks and local area networks, intranets, extranets, and other distributed networks. Examples of video conferencing are shown and described in U.S. patent application Ser. No. 09/984,499 filed Oct. 30, 2001 (the “499 application”), which is incorporated by reference in its entirety.

### SUMMARY OF THE INVENTION

Although the 499 application provides sources of digital video streams and digital audio streams distributed through a network to real time participants and pseudo-participants of video conferences, none of these systems provide an individual, participant or pseudo-participant with the capability of leaving a digital video stream, digital audio stream, or a combined digital video and digital audio stream as a message for an intended recipient for later viewing upon the request of the intended recipient.

This invention provides systems and methods that allow video and audio data streams to be transmitted from an end point to a remote server and the video and audio data streams to be stored on the remote server as a message, which can be viewed at a later time from an end point, computing device, or Internet Protocol (IP) phone.

Some of the exemplary embodiments of this invention provide systems and methods for transmitting a message from a calling device to a remote video mail server and for retrieving the message by a communication device at a later time over a distributed network.

Some of the exemplary embodiments of this invention provide systems and methods for connecting a calling device to a remote video mail server, supplying a message from a calling device to the remote video mail server, storing the message on the remote video mail server, and accessing the message by the communication device from the remote video mail server at a later time.

In some of the various exemplary embodiments of the systems and methods according to this invention, a calling device is one of an end point and an internet protocol phone.

In some of the various exemplary embodiments of the systems and methods according to this invention, a communication device is one of an end point, computing device and an internet protocol phone.

In some of the various exemplary embodiments of the systems and methods according to this invention, a computing device is one of a personal computer, a wireless computer and a personal digital assistant.

In some of the various exemplary embodiments of the systems and methods according to this invention, a message comprises a video data stream.

In some of the various exemplary embodiments of the systems and methods according to this invention, a message comprises a video end audio data stream.

In some of the various exemplary embodiments of the systems and methods according to this invention, accessing a message from a remote video mail server through a communication device at a later time further comprises supplying a list of at least one message from the remote video mail server to the communication device, selecting one of the messages from the list of at least one message using the communication device, and supplying the selected one of the messages from the remote video mail server to the communication device.

In some of the various exemplary embodiments of the systems and methods according to this invention, the communication device has a display and at least one media player for displaying messages.

In some of the various exemplary embodiments of the systems and methods according to this invention, supplying the selected message from the video mail server to the communication device further comprises converting the stored message into a format which can be read by the at least one media player for displaying messages.

In some of the various exemplary embodiments of the systems and methods according to this invention, transmitting a message from a calling device to a remote video mail server and retrieving the message by a communication device at a later time over a distributed network further comprises supplying a list of at least one message from the remote video mail server to the communication device, selecting one of the messages from the list of at least one message using the communication device, displaying the at least one media player, and selecting one media player from the at least one media players for displaying the selected message.

In some of the various exemplary embodiments of the systems and methods according to this invention, selecting one media player further comprises converting the stored message into a format which can be read by the at least one media player for displaying messages.

In some of the various exemplary embodiments of the systems and methods according to this invention, a message is stored in the video mail server in its original format.

In some of the various exemplary embodiments of the systems and methods according to this invention, a message is stored in the video mail server in the H.323 standard format.

In some of the various exemplary embodiments of the systems and methods according to this invention, accessing a message from the remote video mail server through a communication device at a later time further comprises authenticating access to the message.

In some of the various exemplary embodiments of the systems and methods according to this invention, transmitting a message from a calling device to a remote video mail server and retrieving the message by a communication device at a later time over a distributed network further comprises notifying at least one intended recipient of the message stored in the video mail server.

In some of the various exemplary embodiments of the systems and methods according to this invention, the message is in a MP3 format.

In some of the various exemplary embodiments of the systems and methods according to this invention, the message is in a compressed format.

In some of the various exemplary embodiments of the systems and methods according to this invention, the calling device is connected to the video mail server through a multi-point control unit.

Some of the exemplary embodiments of this invention provide a system and method for transmitting a digital audio data stream and a digital video data stream as a message over a distributed network for retrieving the message at a later time including a calling device outputting the digital audio data stream and a digital video data stream as the message to the distributed network, a remote video mail server connectible to the distributed network to receive and store the message and permitting access to the message for later viewing, and a communication device communicating with the remote server to access the message.

In some of the various exemplary embodiments of the systems and methods according to this invention, the end point is coupled to a video conference.

In some of the various exemplary embodiments of the systems and methods according to this invention, the communication device includes at least one media player.

In some of the various exemplary embodiments of the systems and methods according to this invention, the remote video mail server is coupled to an internet protocol phone through an internet protocol public branch exchange.

In some of the various exemplary embodiments of the systems and methods according to this invention, the remote video mail server communicates with a gatekeeper.

In some of the various exemplary embodiments of the systems and methods according to this invention, the remote video mail server includes a gatekeeper.

In some of the various exemplary embodiments of the systems and methods according to this invention, the remote video mail server contains a storage unit which stores messages in video mailboxes.

In some of the various exemplary embodiments of the systems and methods according to this invention, the communication device includes a display and a media player for displaying the message on the display, the communication device requests the message in the media format which can be accessed by the media player, the remote video mail server converts the stored message into the media format and transmits the message in the media format to the communication device, and the media player of the communication device reads the media format and displays the message on the display.

In some of the various exemplary embodiments of the systems and methods according to this invention, the communication device includes a display and a media player for displaying the message on the display, the remote video mail server supplies a list of at least one message to the communication device, and the communication device enables selection of the at least one message and forwards the selected message to the remote video mail server.

In some of the various exemplary embodiments of the systems and methods according to this invention, the remote video mail server converts the stored message into a media format and transmits the message in the media format to the communication device, and the media player of the communication device reads the media format and displays the message on the display.

In some of the various exemplary embodiments of the systems and methods according to this invention, the communication device displays the at least one media player, a communication device enables selecting one media player from the at least one media player for displaying the message, the communication device forwards the selection of the media player to the remote video mail server, the remote video mail server converts the stored message into the selected format which can be read by the selected at least one media player for displaying messages, the remote video mail server forwards the message in the selected format to the communication device, and the media player of the communication device reads the media format and displays the message on the display.

In some of the various exemplary embodiments of the systems and methods according to this invention, the remote video mail server notifies the intended recipient of the message stored in the video mail server.

In some of the various exemplary embodiments of the systems and methods according to this invention, the distributed network is the Internet.

In some of the various exemplary embodiments of the systems and methods according to this invention, the remote video mail server requests authentication from the communication device and the communication device forwards the authentication.

In some of the various exemplary embodiments of the systems and methods according to this invention, a multi-point control unit communicates with at least one calling device and the video mail server.

These and other features and advantages of this invention are described in or are apparent from the following detailed description of various embodiments of the systems and methods according to this invention.

### BRIEF DESCRIPTION OF THE DRAWINGS

Various exemplary embodiments of this invention will be described in detail, with reference to the following figures, wherein:

FIG. 1 is a block diagram illustrating a related art system for transmitting audio and video data streams to a distributed network;

FIG. 2 is a block diagram of another related art system for transmitting audio and video data streams to a distributed network;

FIG. 3 is a block diagram of a first exemplary embodiment of this invention, which is a system that couples end points to a remote server through a distributed network to leave messages consisting of audio and/or video digital data streams from one of the end points, and for transmitting the saved audio and video data streams through the distributed network to another end point or a computing device upon the request of the intended recipient of the message;

FIG. 4 is a block diagram of a second exemplary embodiment of this invention, which is a system that couples end points to a remote server through a distributed network to leave messages consisting of audio and/or video digital data streams from one of the end points, and for transmitting audio and video data streams through the distributed network to another end point, a computing device, or an Internet Protocol (IP) phone upon the request of the intended recipient of the message;

FIG. 5 is a block diagram of a third exemplary embodiment of this invention, which is a system that couples end points to a remote server through a distributed network to leave messages consisting of audio and/or video digital data streams from one of the end points, and for transmitting the saved audio and video data streams through the distributed network to another end point, a computing device, or an Internet Protocol (IP) phone upon the request of the intended recipient of the message;

FIG. 6 is a flowchart outlining an exemplary embodiment of this invention, which is a method for placing a call through a distributed network from one end point to another end point, computing device, or an IP phone, and for leaving messages consisting of audio and/or video data streams on the remote server when the intended recipient of the call is unavailable;

FIGS. 7A-7B are a flowchart outlining an exemplary embodiment of this invention, which is a method for retrieving a message consisting of audio and/or video data streams from a remote server when the intended recipient of the call requests access to the message through a computing device;

FIGS. 8A-8B are a flowchart outlining an exemplary embodiment of this invention, which is a method for retrieving a message consisting of audio and/or video data streams from the remote server when the intended recipient requests access to the message through an IP phone; and

FIGS. 9A-9B are a flowchart outlining an exemplary embodiment of this invention, which is a method for retrieving a message consisting of audio and/or video data streams from the remote server when the intended recipient requests access to the message through an end point.

### DETAILED DESCRIPTION OF PREFERRED EMBODIMENTS

The following detailed description of the exemplary embodiments is particularly directed to an audio and video mail system. Thus, the following detailed description of various exemplary embodiments of systems and methods according to this invention makes specific reference to an audio and video mail system which captures video and audio messages, supplies the messages to a remote server over a distributed communication network for storage, and supplies one or more of the messages stored in the remote server to the intended recipients (client) over the distributed communication network at the requests of the intended recipients at a later time. The messages supplied to the intended recipients are in the form of audio and/or video data streams, which are supplied to communication devices preferably operated by the clients. These communication devices can be computing devices, internet protocol phones, end points, or the like.

While the described exemplary embodiments are directed to an audio and/or video mail system, the invention is not limited to these embodiments.

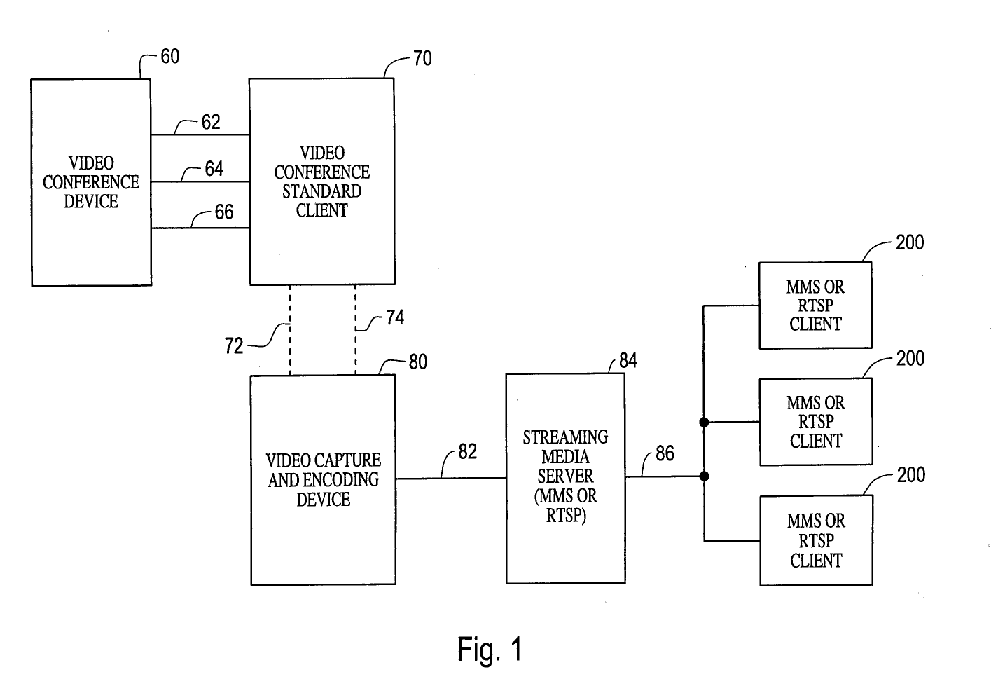

Systems and methods for porting the audio and video data streams (signals) of a video conference from end points to a distributed network, such as the Internet, are shown and described in the 499 application. There are several techniques and systems for re-encoding the audio and video portions of captured video and audio signals for this transmittal. For example, one system and technique includes capturing the video and audio portions of the video conference separately, by accessing the analog auxiliary audio and video outputs on one of the video conference end point devices that are participating in a particular video conference session. This first system is illustrated in related art FIG. 1.

As shown in FIG. 1, an end point (video conference) device 60 implementing a video conference standard outputs three data streams 62-66 to a video conference standard client 70. The three streams of data 62-66 include a video conference standard messaging stream 62, a digital video stream 64 and a digital audio stream 66. The messaging stream 62 is not a video message or voice message. Rather, the messaging stream 62 provides protocols. Each of the video streams 62-66 can be bidirectional between the video conference device 60 and the video conference standard client 70. Each of the digital video conference standard messaging stream 62, the digital video stream 64 and the digital audio stream 66 are transmitted between the video conference device 60 and the video conference standard client 70 using an Internet protocol (IP) packet transport method. The digital video stream 64 and the digital audio stream 66 are transmitted between the video conference end point device 60 and the video conference standard client 70 using the Internet Engineering Task Force (IETF) Real Time Protocol (RTP).

The video conference standard client 70 converts the digital video stream 64 into an analog composite video signal 72. The video conference standard client 70 also converts the digital audio signal 66 into a analog line-level audio signal 74. Analog composite video signal 72 and analog line-level audio signal 74 are output to a video capture and encoding device 80. The analog composite video signal 72 and the analog line-level audio signal 74 can be unidirectional signals from the video conference standard client 70 to the video capture and encoding device 80.

The video capture and encoding device 80 captures the analog video frames within the analog video signal 72 and digitizes the analog audio signal 74. The video capture and encoding device 80 then generates, from the captured analog video frames and the digitized audio signal, digital video and audio signals and encodes the digital video and audio signals as video and audio streams, or a combined audio/video data stream, for transmission over a distributed network, such as the Internet. In particular, the video capture and encoding device 80, depending on the particular streaming software being used, encodes and packetizes the digitized audio and video data using different formats based on the selected streaming software being used. For example, Microsoft and Real Networks use proprietary, closed-system encoding and transmission protocols. In contrast, Apple has developed the open system named “QuickTime”, while the Internet Engineering Task Force (IETF) has developed the Real Time Streaming Protocol (RTSP). Any of these open-system or closed-system encoding and packetizing methods can be used by the video capture and encoding device 80 to convert the analog data received from the video conference standard client 70 into digital data suitable for transmission over a distributed network. The video capture and encoding device 80 then outputs the digitized and packetized video and audio data streams 82 to a streaming media server 84.

The streaming media server 84 can output, for example, the digitized and packetized audio and video data as a unicast audio/video data stream 86 using the Microsoft® Windows® Media Protocol (Windows® MMS) or the Real Time Streaming Protocol (RTSP). The output video/audio stream 86 can then be received by any number of clients 200 connected to the distributed network over which the audio/video stream 86 is distributed.

As discussed above, the system shown in FIG. 1 converts the digital video and audio streams 64, 66 of the video conference output by the video conference device 60 into the analog output streams 72, 74 output by the video conference standard client 70. These analog output streams are also used to drive the audio and visual display devices used by the actual video conference participants. The system shown in FIG. 1 reconverts the audio and video streams back into digital data streams. As a result, the system shown in FIG. 1 can significantly degrade or otherwise distort the video and audio data.

Additionally, as a result of these conversion and reconversion steps, there is a significant delay between receiving the digital video and audio streams at the video conference end point device 60 and transmitting the re-encoded digital video and audio streams, such as data stream 86. This latency can be as long as 40 seconds. Finally, the system shown in FIG. 1 requires a physical connection between the video conference standard client 70 and the video capture encoding device 80 to transmit analog signals 72 and 74. As a result, each video capture encoding device 80 can be connected to at most one video conference standard client 70.

A second system for re-encoding the audio and video portions of the captured audio and video signals uses a different type of video conference equipment than described above, which equipment allows three or more participants to participate in a video conference without a multi-point control unit. This second system connects the end point equipment of the various participants in a peer-to-peer style network, such that each end point receives the video and audio data streams directly from each of the other end points. This is commonly described as multi-tasking the video conference across the network. In this system, an IPTV client, which is a software application available from Cisco Systems, can be connected to the network to view the data packets of a video conference session as the data packets are passed back and forth between the actual end points participating in the video conference. The IPTV client, while not directly participating in the conference, monitors all of the packets that are transmitted between the end points of the video conference session.

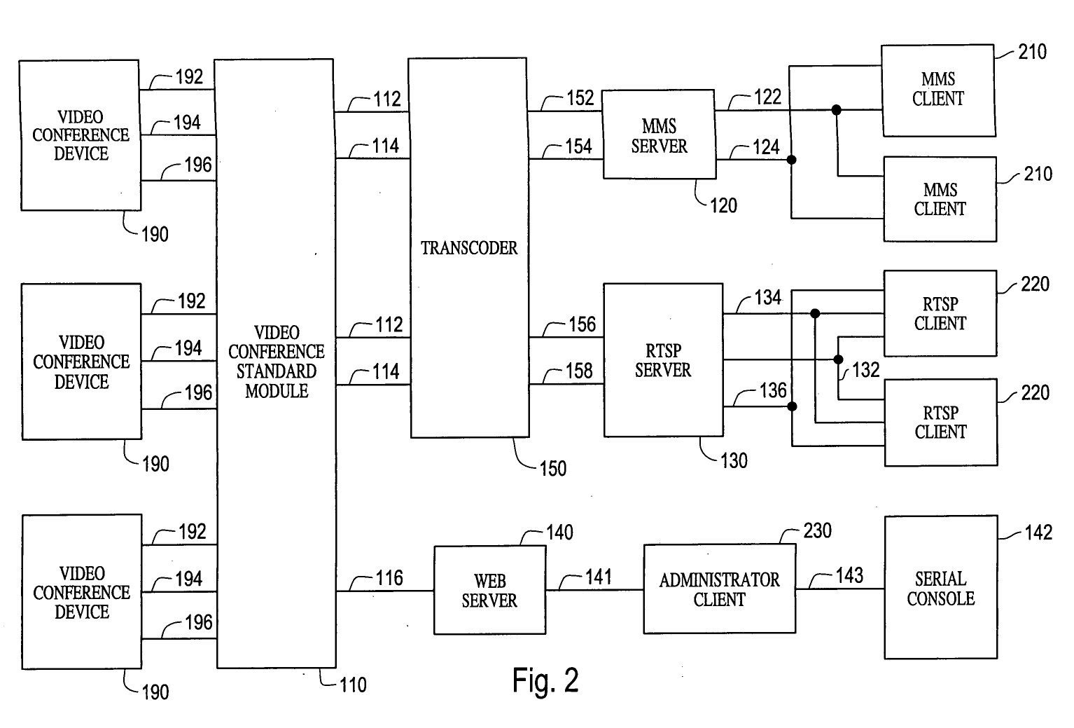

A third technique and system for re-encoding the audio and video portions of captured audio and video signals is described and shown in the 499 application. FIG. 2 is a block diagram illustrating this third technique and system, and includes a video conference access system to transmit a video conference session to a distributed network. As shown in FIG. 2, the video conference access system includes a video conference standard module 110 (which is a video-conference-standard device) connected to a plurality of video conference end point devices 190 and one or more of an MMS (or other proprietary system) server 120, an RTSP server 130 and a web server 140. If provided, the MMS (or other proprietary system) server 120 is connected by a messaging channel 122 and outputs audio/video streams 124 to one or more MMS (or other proprietary system) clients 210. The RTSP server 130 is connected by an RTSP messaging channel 132, and outputs video streams 134 and audio streams 136 to one or more RTSP clients 220.

In this embodiment, a transcoder 150 is located between the video conference standard module 110 and the MMS server 120 and the RTSP server 130. The transcoder 150 converts the audio and video data streams 112 and 114 received from the video conference standard module 110 from the form output by the video conference standard module 110 to one or more different video and audio streams (152, 154, 156, and 158) usable by various ones of the clients 210 and/or 220. The transcoder 150 may be omitted under certain conditions, such that the MMS server 120 and the RTSP server 130 are directly connected to video conference standard module 110.

The web server 140 is connected by a link 141 to an administrator client 230, which is also connected by a link 143 to a serial console 142. In particular, it should be appreciated that the other clients 210 and 220 are not necessarily part of the video conference access system, while the web server 140, the administrator client 230 and the serial console 142 are generally part of the video conference access system. However, one or more of the web server 140, administrator client 230 and the serial console 142 can be omitted from the video conference access system.

In the video conference access system of FIG. 2, each of the video conference end point devices 190 outputs three data streams to the video conference standard module 110. These data streams include a bi-directional digital video conference standard messaging stream 192, a unidirectional digital video stream 194 and a unidirectional digital audio stream 196. Each of the video and audio streams are encoded using the real time protocol (RTP). Each of the streams 192-196 are transmitted between the video conference end point device 190 and the video conference standard module 110 using an Internet protocol (IP) packet transport technique.

Each of the provided servers 120 and 130 receive unidirectional digital video streams 112 and audio streams 114 from the video conference standard module 110. Each of these data streams 112 and 114 is transmitted using an internal digital transport technique. The video conference standard module 110 communicates with the web server 140 using a bi-directional digital messaging stream 116. This digital messaging stream 116 is also transmitted using the internal digital transport method discussed above with respect to the data streams 112 and 114. In various exemplary embodiments, the bi-directional digital messaging stream 116 may use a proprietary protocol.

While various ones of the channels and streams are variously described as bidirectional or unidirectional, each of the channels and streams disclosed as unidirectional can be replaced with one or more bi-directional channels or streams. Similarly, each of the channels disclosed as bi-directional can be replaced with one or more unidirectional channels or streams. Likewise, each unidirectional channel or stream can be implemented as two or more unidirectional channels or streams, and each bi-direction channel or stream can be implemented as two or more bi-directional channels or streams.

This third system provides several advantages over the system illustrated in FIG. 1. Initially, the video conference end point device 190 can be located anywhere relative to the other video conference participants. Thus, the video conference standard module 110, unlike the video capture and encoding device 80, is not limited to being located in the same room, or even in the same physical structure, as the video conference equipment of one or more of the participants to the video conference.

Additionally, because each video conference end point device 190 does not have to have any specific relationship to the other video conference participants, multiple video conference end point devices 190 can be connected to the video conference standard module 110 and act as “pseudo-participants” (discussed below) to a variety of different video conference sessions at the same time. Thus, the video conference access system of FIG. 2 can function as a video conferencing network appliance. This video conference access system can work with any Internet protocol (IP)-based video conference standard network, or even, via an ISDN to video conference standard gateway, with H.320 or H.323 video conferencing systems. The video conference access system connects with other video conferencing equipment like any other end point device. This allows an end point device 60 of FIG. 1 to connect to one of the video conference end point devices 190 directly, or for one of the video conference end point devices 190 to connect to a multi-point conference through a multi-point control unit.

The video conference standard module 110 of the video conference access system takes advantage of existing encoded video and audio data that is already being transmitted between the participants of the particular video conference session. The video conference standard module 110 can repackage the existing encoded video data for conventional streaming media players, so that “participants” or “pseudo-participants” can listen and/or view the video conference. A “pseudo-participant” is a client who can not participate in the video conference, but can listen and/or view the video conference. The video conference standard module 110 can transmit audio and/or video streams to unicast and/or multicast servers and/or clients.

In addition, the unicast servers include servers able to output unicast multimedia data streams using the Microsoft® Windows® Media Player®, the Apple® QuickTime® player, the Real Networks® Real® player, or the like. The video conference standard module 110 takes advantage of the high-quality video compression hardware present in the video conference end point devices 190. In general, due to the video and audio data remaining in digital format from the time the video and audio streams are received by the video conference end point device 190 until the video and audio streams are transmitted to the clients 210 and 220, there is little to no latency caused by the video conference access system, such as that caused by the software digitizing and encoding of the system shown in FIG. 1.

Moreover, because the clients 210 and 220 receive the exact video and audio signals received by video conference and point devices 190, the video and audio output to the users of the clients 210 and 220 is enhanced relative to the video and audio outputs to users of the clients 200 of the system shown in FIG. 1.

Although three systems and techniques for distributing video and audio streams through a network to real time participants and pseudo-participants of video conferences have been described above, the end points and systems described above do not provide an individual participant or pseudo-participant with the capability of leaving digital video streams, digital audio streams, or combined digital video and digital audio streams as a message for an intended recipient for later access upon the request of the intended recipient (client).

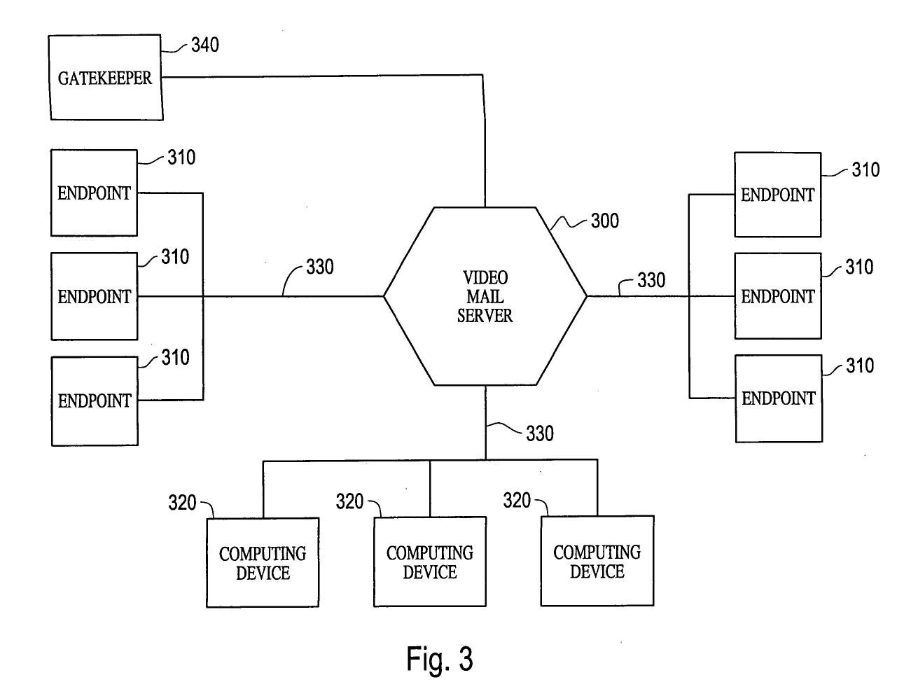

FIG. 3 is a block diagram of a first exemplary embodiment of this invention, which is a system that couples end points to a remote server through a distributed network to leave messages consisting of audio and/or video digital data streams from the end points and for transmitting the saved audio and video digital data streams through the distributed network to the end points or computing devices upon the request of the intended recipient of the message.

As discussed above, end point equipment is used by participants in a video conference to convert the audio and video signals from the camera, microphone, etc. into data streams transmittable to another end point device. In certain exemplary embodiments, a camera, microphone, or other image, audio, or combined image and audio capturing device can be considered part of the end point. In other exemplary embodiments, an end point can also be used to leave a message on a video mail server or retrieve a message from a video mail server, as well as function as part of a video conference. This message can comprise a video data stream, an audio data stream, or a combined video and audio data stream. As used herein, the term “client” refers to the intended recipient of a message left on a video mail server as well as the owner of the mailbox that the message was left in regardless of the type of equipment used to retrieve the message from the video mail server.

As shown in FIG. 3, the video mail server 300 communicates with end points 310 and computing devices 320 over a distributed network 330. The computing devices 320 can be any type that allow for the transmission and/or reception of communication signals using communication standards (discussed below). For example, the computing devices 320 can be personal computers, workstations, wireless computers, wireless personal digital assistants (PDAs), and the like. The end points 310 and the computing devices are preferably coupled to the video mail server 300 by way of a web interface using a web browser such as Microsoft®, Internet Explorer® or any other similar browser either existing or yet to be invented.

As stated, the video mail server 300 communicates with end points 310 and computing devices 320 preferably using a communication standard. As used herein, the term “communication standard” encompasses the H.323 standard, the SIP standard, the H.320 standard, and any other known or later-developed standard that provides for the communication of audio, video or a combined audio and video signals. Such standards will usually provide for one or more of some form of call routing, some form of call signaling and alerting, some form of negotiation regarding the capabilities of the video mail servers and end points and the parameters to be used to communicate, and some form of releasing of the resources allocated to the communication.

The video mail server 300 may support delivery of the contents in the Microsoft® Windows® Media Protocol, the Apple® QuickTime Protocol, the Real Networks® Real Protocol, the Internet Engineering Task Force (IETF), Real Time Streaming Protocol (RTSP), or any other know or related developed protocol. Therefore, the clients may view and listen to the audio and video digital data stream (message) in any one of the commonly available stream media players including Microsoft® Windows® Media Player®, the Apple® QuickTime® players, the Real Networks® Real® player or any other player either existing or yet to be invented that is capable of receiving streaming media audio and video information. In addition, it should be appreciated that the video mail server 300 and the media players can deliver and support a MPEG-1 Layer 3 (MP3) format or other compressed format.

In addition, the video mail server 300 may also communicate with a gatekeeper 340. The gatekeeper 340 is preferably a domain name server, which translates information in an internal data base to actual internet protocol (IP) addresses, so that communications such as video calls can be properly routed to a client or a video mailbox in the video mail server 300. Where technologies other than H.323 communication standard are used, another device that handles translations of naming schemes may be substituted for the gatekeeper 340. The gatekeeper 340 or a similar device may also be integrated into the video mail server 300. The end points 310 can communicate with the video mail server 300 directly or communicate with the gatekeeper 340 to obtain information to direct end points 310 to video mail server 300.

The video mail server 300 archives messages, which are supplied by end points 310, and which can be retrieved by intended recipients (clients) using a computing device 320 or other end points 310. The messages are preferably archived into video mailboxes in the video mail server 300. In certain exemplary embodiments, the video mail server 300 includes one or more storage devices, which can be implemented using any appropriate combination of alterable, volatile or non-volatile memory or non-alterable or fixed memory. The alterable memory, whether volatile or non-volatile, can be implemented using any one or more of static or dynamic RAM, a floppy disk and disk drive, a writable or re-writable optical disk and destruct, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like. The message that a caller leaves can be stored in the video mail server 300 using any non-volatile form of data storage either existing or yet to be invented. For example, the message can be stored in a non-volatile video mailbox that is either existing or is yet to be invented in the video mail server 300.

In certain exemplary embodiments, an Internet Protocol (IP) address can be assigned to and user (client) accounts can be set up for clients of the video mail server 300. A network administrator can register the video mail server 300 with the gatekeeper 340 or another gatekeeper. The network administrator can set the availability of the clients in the gatekeeper, and can set up group video mailboxes. These group video mailboxes can be accessed by several clients, or can forward a message left in the group video mailbox to the individual video mailboxes of the members of the group. The network administrator can also lock/unlock mailboxes, set message expiration limits, and set message limits. Message expiration provides the capability of the video mail server 300 to delete a message that has been stored for longer than a preset time period, in order to save space. Message limits is the size of the video mailbox (amount of memory allocated for messages).

In certain exemplary embodiments, a recipient of a message using a computing device 320 will be prompted with a menu of both his or her new messages and messages that have been saved on the video mail server 300 for later viewing. Then, once the recipient has selected the message he or she wishes to review, the recipient can select from a menu of supported media players for viewing the content of the message.

If an end point 310 is similar to the end point 60 in FIG. 1, the video mail server 300 may include a video conference standard client 70, a video capture and encoding device 80, a streaming media server 84, and a memory, so that the video mail server 300 can receive and store messages from an end point 60 as well as transmit stored messages to a client at the request of the client. Alternatively, if the end point 310 is similar to end point 190 of FIG. 2, the video mail server 300 may include one or more of a video conference standard module 110, MMS server 120, RTSP server 130, web server 140, administrator client 230, serial console 142, a transcoder 150, and a memory. Each of the above elements can be implemented as physically distinct hardware circuits within an ASIC, or using a FPGA, a PLD, a PLA, or a PAL, or using discreet logic elements or discreet circuit elements. Each of the elements could also be implemented using standard multipurpose digital devices, some of which may be programmable. Each of the above elements can be integrated into the video mail server 300 or be separated from the video mail server 300. The particular form of each of the elements is a design choice and the various forms are well known in the technology.

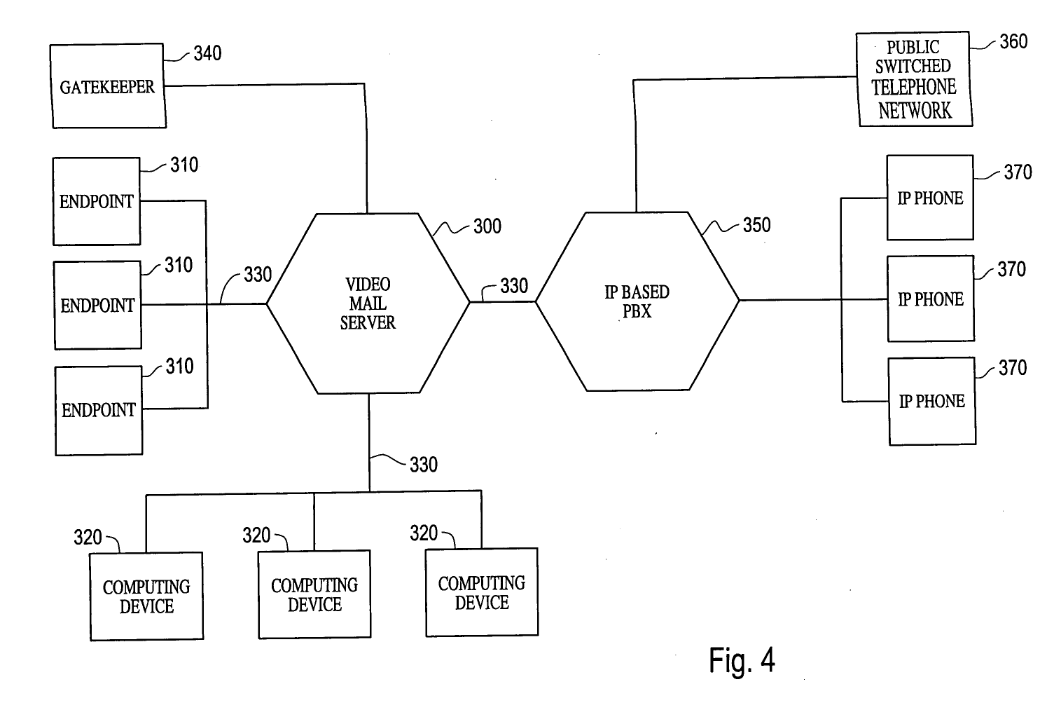

FIG. 4 is a block diagram of a second exemplary embodiment of this invention, which is a system that couples end points, telephones, computing devices, etc. to a remote server through a distributed network to leave messages in the form of audio and video data streams from the end points, telephones, computing devices, etc. on the remote server and for transmitting these saved messages from the remote server through the distributed network to the desired end points, computing devices, or Internet Protocol (IP) phones upon the request of the message recipients.

In this exemplary embodiment, video mail server 300 is coupled to end points 310, computing devices 320 and an IP Based PBX 350 by distributed network 330. IP Based PBX 350 is also coupled to a public switched telephone network 360 and Internet Protocol (IP) phones 370. As used herein, the term “IP Based PBX System” encompasses all Public Branch Exchange (PBX) phone systems that employ digital signaling for call transmission and routing regardless of the protocols used for said routing, be it an existing system or a system yet to be developed. The term also includes any hybrid systems that use analog switching but have a digital subsystem to allow them to interact with a network based device. The term will also apply to both circuit switched and packet switched network.

In this embodiment, the video mail server 300 receives and archives messages from end points 310, Internet Protocol Phones 370, and the public switched telephone network (PSTN) 360. The PSTN 360 is coupled to telephones (not shown). Calls from the Internet Protocol Phones 370 and PSTN 360 are routed through the IP Based PBX system 350 to the video mail server 300 when the intended recipients do not answer the calls. Calls from the end points 310, computing devices 320, IP phones 370 and PSTN 360 to leave or listen to messages may be routed using the gatekeeper 340, which may be integrated into the video mail server 300 or separate from the video mail server 300. The message that the caller leaves can be stored in the video mail server 300 in a video mailbox of the intended recipient using any non-volatile form of data storage either existing or yet to be developed, as discussed above.

As also discussed above, the messages stored on the video mail server 300 can be retrieved by the IP phones 370 (i.e., accessed by the IP phones 370). The video mail server 300 will accept information from the IP phone keypads or other specialized keys for authentication, message selection or any other function necessary to support the user, operator, or client to retrieve his or her messages.

As in the exemplary embodiment shown in FIG. 3, the end points 310 and computing devices 320 shown in FIG. 4 connect to the video mail server 300 directly or communicate with the gatekeeper 340 to obtain information to direct endpoints 310 to video mail server 300. The gatekeeper 340 may also direct calls coming from the IP based PBX system 350 to leave or check messages. The caller can leave messages for other users connected to the IP based PBX system 350 or check for messages that are left in the caller's video mailbox if the caller is a client of the video mail server 300.

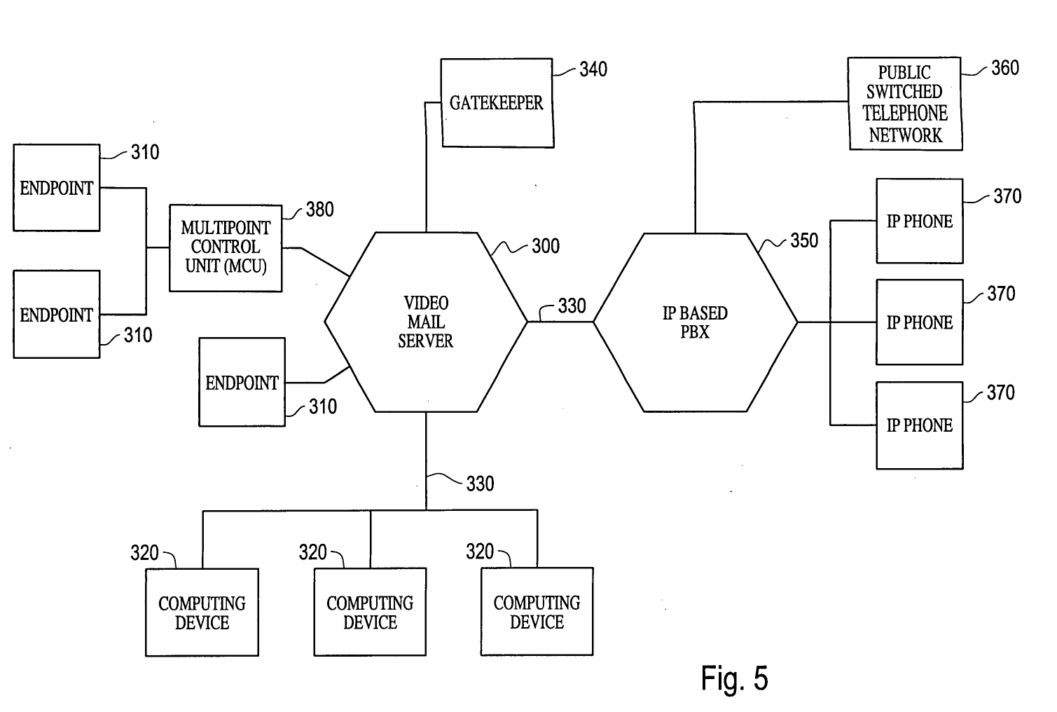

FIG. 5 is a block diagram of a third exemplary embodiment of this invention, which is a system that couples end points and/or a multipoint control unit (having end points connected to it) to a remote server through a distributed network to leave messages from the end points in the form of audio and video data streams on the remote server, and for transmitting the messages through the distributed network to the desired end points, computing devices, or Internet Protocol (IP) phones upon the request of the intended recipients of the messages.

In this third exemplary embodiment, both an end point 310 and a multipoint control unit 380 are coupled to the video mail server 300. The multipoint control unit 380 can, in turn, be coupled to one or more end points 310. Accordingly, video mail server 300 can receive a multipoint call from the multipoint control unit 380 and record a message for later viewing by one or more clients. The multipoint control unit 380 facilitates the connection of multiple end points 310 to the video mail server 300 so that users in different locations can leave a message for one or more clients. In addition, the multipoint control unit 380 can operate in at least two modes, such as continuous presence mode and switched mode. In the continuous presence mode, all participants in a call are visible at all times, and in a switched mode, only the speaker is visible. The video mail server 300 can record a message when the multipoint control unit 380 is in any of these modes.

The video mail server 300 can also receive and transmit messages received from other end points 310, IP phones 370 and phones (not shown) connected to the public switch telephone network 360. As in the exemplary embodiment shown in FIG. 4, the end points 310, multipoint control unit 380 and computing devices 320 shown in FIG. 5 connect to the video mail server 300 directly or communicate with the gatekeeper 340 to obtain information to direct endpoints 310 to video mail server 300. The gatekeeper 340 may also direct calls coming from the IP based PBX system 350 to leave or check messages.

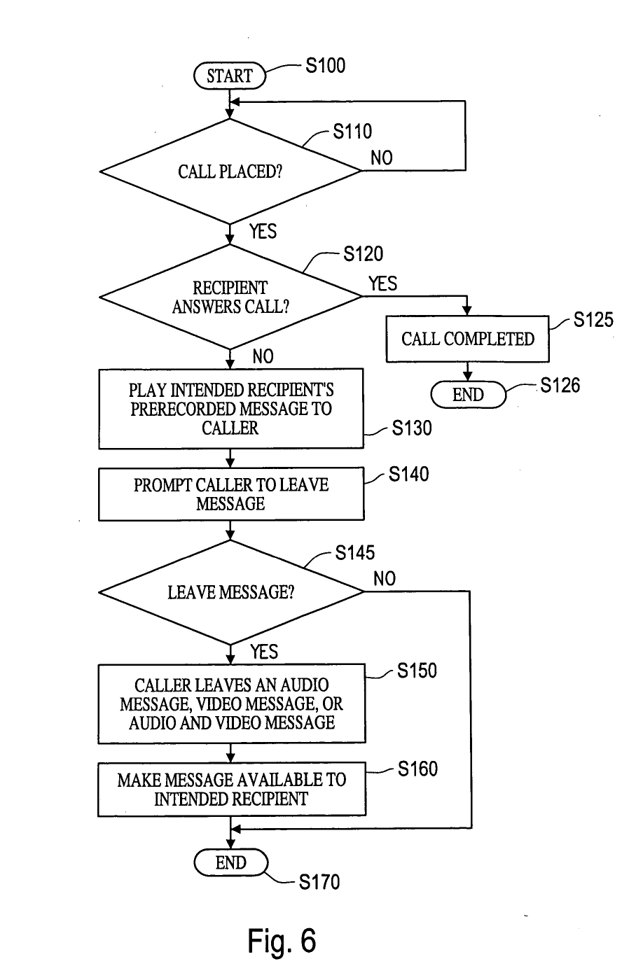

FIG. 6 is a flowchart illustrating an exemplary process according to this invention for placing a call through a distributed network to another communication device, such as another end point, computing device, or an IP phone, and for leaving audio and video digital data streams as a message on the remote server when the intended recipient of the call is unavailable. The call may be initiated by an endpoint 310 or an IP phone 370. The endpoint 310 or IP phone 370 initiating the call may be referred to as a calling device.

The process starts at step S100-start. The next step is step S110 at which the placement of a call is detected. The call can be an audio, a video or a combined audio and video call. Once the system detects a call, control moves to S120. If the intended recipient of a call answers the call, the call is completed in step S125. Once the intended recipient ends the call, control continues to S126, which is the termination of the processing of this call on this flowchart.

Alternatively, if the intended recipient of a call does not answer the call, control moves from step S120 to step S130. In certain embodiments, an unanswered call may be detected by the gatekeeper 340. The gatekeeper 340 may also recognize a do-not-disturb status of the intended recipient. Under either of these conditions, control moves from step S120 to step S130.

In step S130, the voice mail server 300 transmits the intended recipient's prerecorded message to the caller. The prerecorded message may be an audio message, a video message, or a combined audio and video message. Once the prerecorded message is played to the caller, control moves to step S140 to prompt the caller to leave a message for the intended recipient. After the caller is prompted in step S140, control continues to step S145. If the caller does not wish to leave a message, the process skips steps S150 and S160 and the processing of this flowchart would terminate at step S170. If the caller wishes to leave a message, control continues to step S150 where the caller can leave an audio message, video message, or a combined audio and video message in step S1150, in the form of data streams. It should be appreciated that step S150 may have a time limit or other types of memory limits. If these limits are about to be reached or are reached, the process may notify the caller in step S150 and only permit the part of the message within the limits to be recorded.

After the message is ended in step S150, either by the caller or when the message limit is reached, control continues to step S160 where the video mail server 300 makes the message available to the intended recipient. The step S160 may include notifying the intended recipient by sending an e-mail, page or other notification from the video mail server 300 to a communication device of the intended recipient. Control continues to step S170 to end the process of leaving a message for the intended recipient.

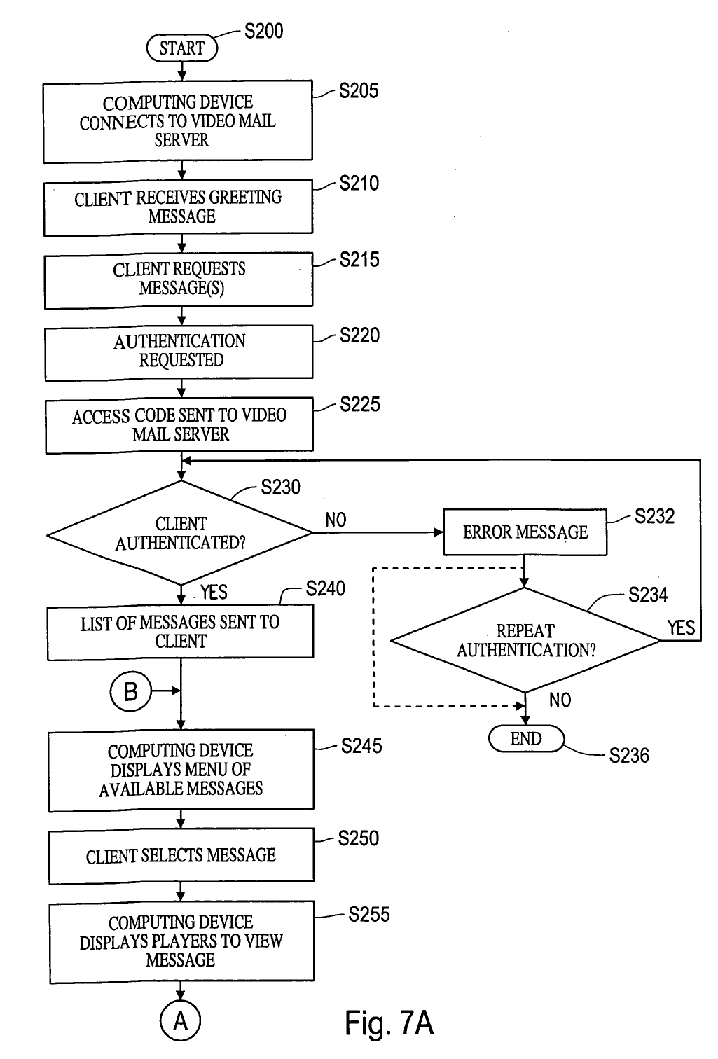

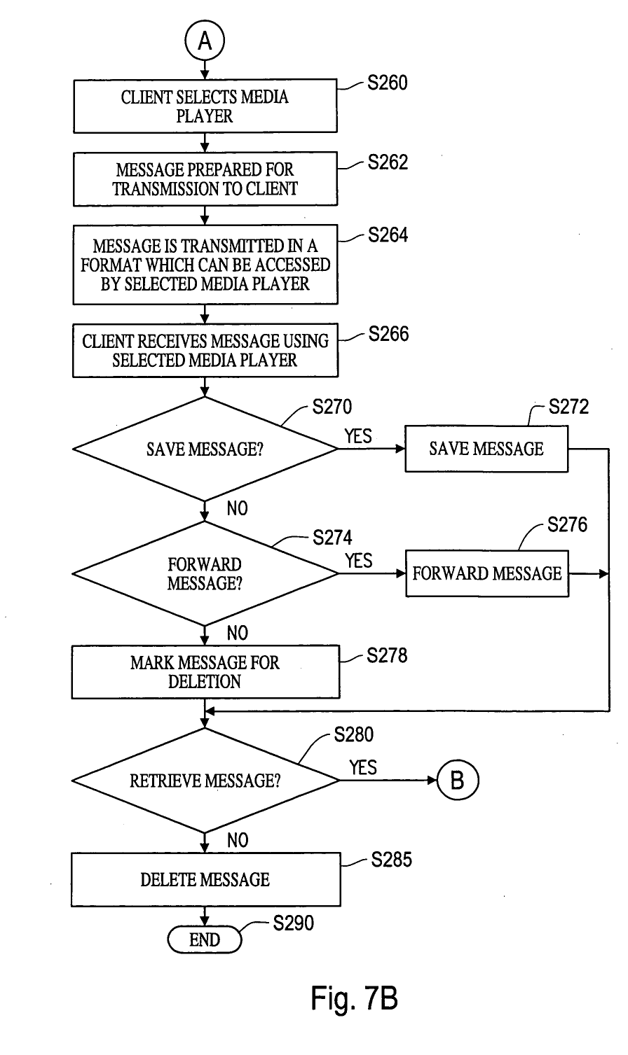

FIGS. 7A-7B are a flowchart illustrating an exemplary process according to this invention for retrieving the audio and video conference digital data streams (message) from the remote server when the intended recipient of the call requests access to the message through a computing device.

This process starts at step S200-start. The next step is step S205, at which computing device 320 connects to video mail server 300. After the computing device 320 connects to video mail server 300, control continues to step S210 where the client receives a greeting message through computing device 320.

Also in step S210, the computing device 320 can display a personal web page where the client can set up e-mail notifications for new messages, set a media player preference, forward messages to other users, and replay messages. Also, through the personal web page, the client can access an address book to identify other Internet Protocol addresses. Further, the personal web page may notify the client of any messages which are near expiration and when the client's video mailbox is full or almost full.

Control continues to step S215. In step S215, the client requests messages through computing device 320.

After the client requests messages, control continues to step S220 where video mail server 300 requests authentication. In response, the client sends an access code or other type of authentication information to the video mail server by way of computing device 320 in step S225. Many systems can be used to authenticate the client's access including token based authentication, HTTP basic, Microsoft® active directory, lightweight directory access protocol (LDAP), or any other authentication system either existing or yet to be developed.

In other embodiments, the authentication process may occur between other steps in the process, such as at or about the time the computing device is connected to the video mail server, before the client receives the greeting message, etc.

Once the access code is sent to the video mail server 300 in step S225, control continues to step S230 to determine whether the client's access has been authenticated. If the client's access is not authenticated, the computing device receives an error message in step S232. At that time, the process can be ended in step S236, as shown by the dotted line on FIG. 7A. Alternatively, the process may include a one or more additional opportunities for the client to send the proper access code to the video mail server 300. In this alternative, after the error message is displayed in step S232, control continues to step S234 which determines whether authentication should be repeated. If authentication is to be repeated, control continues to step S230. However, if access has been denied a predetermined number of times, for example three times, control continues from step S234 to step S236 and access to messages is denied.

Alternatively, if the client's access is authenticated, control continues to step S240 where video mail server 300 sends a list of the client's messages which are stored in video mail server 300 to computing device 320. In step S245, computing device 320 displays a menu of available messages including new messages and possibly saved messages. In step S250, the client selects a message to be retrieved. Then, control continues to step S255 where the computing device 320 displays the different types of media players which can be utilized to receive the message.

As mentioned above, the video mail server 300 may support delivery of the contents in the Microsoft Windows Media Protocol, the Apple QuickTime Protocol, the Real Networks Real Protocol, the Internet Engineering Task Force (IETF), Real Time Streaming Protocol (RTSP), or any other know or related developed protocol. Therefore, the client may be able to view and listen to the audio and video digital data stream (message) in any one of the commonly available stream media players including Microsoft® Windows® Media Player®, the Apple® QuickTime® players, the Real Networks® Real® player or any other player either existing or yet to be developed that is capable of receiving streaming media audio and video information.

After displaying the list of media players in step S255, control continues to step S260 where the client selects a media player. In alternative embodiments, the media player has already been predetermined (established) and steps S255 and S260 are removed from the flow chart.

Once the client selects a media player in step S260 or the media player is otherwise determined, the video mail server 300 prepares the selected message for transmission in a format which can be accessed by the selected media player in step S262 and transmits the message in that format in step S264. If the message is not stored in the video mail box in the same format as the format needed for the selected media player, the video mail server 300 converts the stored message into the desired format before transmitting the message from the video mail server 300 to the computing device 320 in step S262. In step S266, the client receives and views the message at the computing device 320 using the selected media player. While using the media players, the client may be able to perform desired operations on the message, including but not limited to fast forward, rewind, seek, scan, play, pause and stop. After the message has been received, control continues to step S270.

In step S270, the client has the option of saving the message in the video mail box of the video mail server 300. If the client decides to save the message, control continues to step S272 to save the message in the video mail box in video mail server 300. Alternatively, if the message is not saved, control continues to step S274. In alternative embodiments, the saving process can occur at other times in the process.

In step S274, the client has the option of forwarding the message to another client who has a video mail box on the video mail server 300. If the client decides to forward the message, control continues to step S276 to forward the message to the intended recipient's video mail box in video mail server 300. Alternatively, if the message is not forwarded, control continues to step S278 where the message is marked for deletion from the client's video mail box in the video mail server 300. In other alternative embodiments, the forwarding process may occur at other times in the process.

In step S280, it is determined whether the client wishes to retrieve the same message or another message. If the client wishes to retrieve the same message or a different message, control continues to and repeats step S245. Alternatively, if the client wishes to end the access to the video mail server 300, control continues to step S285 to delete any messages marked for deletion and the call is ended in step S290.

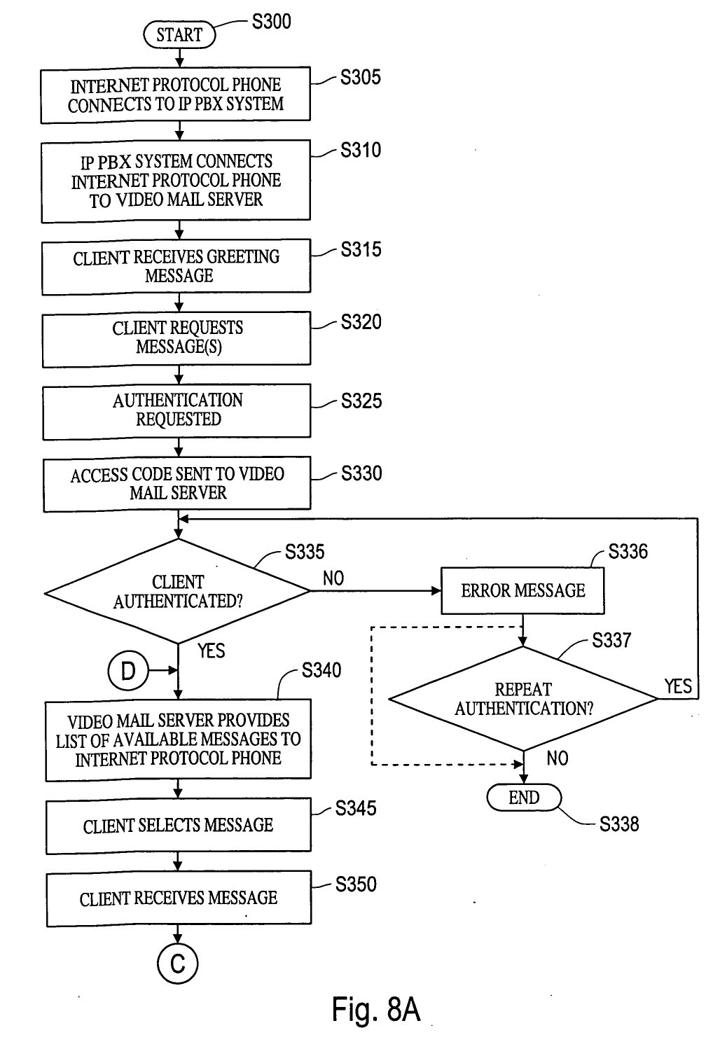

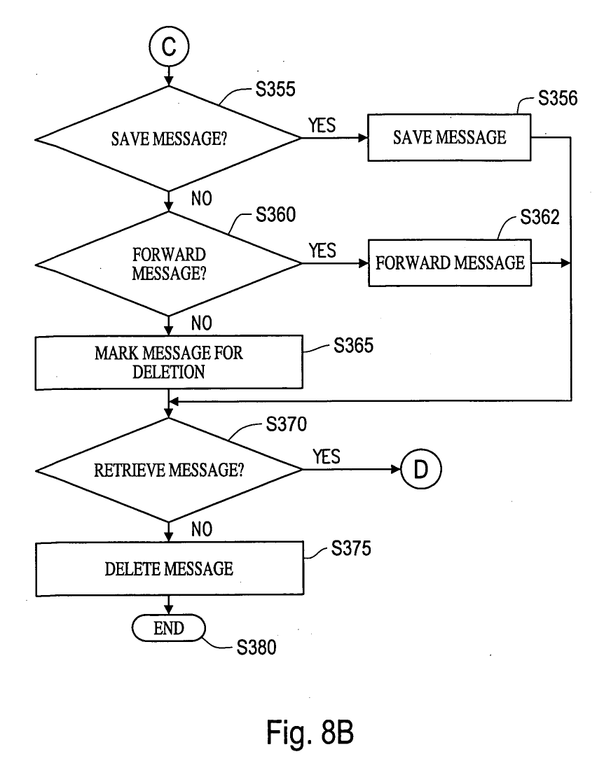

FIGS. 8A-8B are a flowchart illustrating an exemplary process according to this invention for retrieving the audio and video conference digital data streams (message) from the remote server when the intended recipient of the call (client) requests access to the message through an IP phone.

From the start in step S300, control continues to step S305, at which an IP phone connects to an IP PBX system 350. In step S310, the IP PBX system 350 connects the IP phone to the video mail server 300. Control continues to step S315 where the client receives a greeting message. In step S320, the client requests a message.

In response to the client's request, the video mail server requests authentication in step S325. Using the Internet Protocol phone, the client can send an access code or other authentication information to the video mail server in step S330. This code can be sent by dial tone modulation tones or other means. Alternatively, the IP phone can have a video display and may be equipped with a web browser and web page. In this alternative embodiment, many systems can be used to authenticate the client's access including token based authentication, HTTP basic, Microsoft® active directory, lightweight directory access protocol (LDAP), or any other authentication system either existing or yet to be invented.

In other embodiments, the authentication process may occur at other times in the flow chart, such as at or about the time the computing device is connected to the video mail server, before the client receives the greeting message, etc.

Once the access code is transmitted, control continues to step S335 to determine whether the client's access has been authenticated. If the client's access has not been authenticated, an error message is received in step S336. At that time, the process could end at step S338 as shown by the dotted line in FIG. 8A. Alternatively, the process may provide one or more additional opportunities for the client to send the proper access code to the video mail server 300. In this alternative example, after the error message is received in step S336, control continues to step S337 which determines whether authentication should be repeated. If authentication is to be repeated, control continues to step S335. However, if access has been denied a predetermined number of times, for example three times, control continues from step S337 to step S338 and access to messages is denied.

Once the client's access has been authenticated, control continues to step S340 where the video mail server 300 provides a lists of available messages to the IP phone by way of the IP Based PBX system or device 350. In step S345, the client selects a message and control continues to step S350. In step S350, client receives a message. After the message has been received, control continues to step S355.

In step S355, the client has the option of saving the message in the video mail box of the video mail server 300. If it is determined that the message is to be saved, control continues to step S356 to save the message in the video mail box in video mail server 300. Alternatively, if saving the message is not desired, control continues to step 360. In alternative embodiments, the saving process can occur at other stages of the process.

In step S360, the client has the option of forwarding the message to another client who has a video mail box on the video mail server 300. If it is determined that the message will be forwarded, control continues to step S362 to forward the message to the intended recipient's video mail box in video mail server 300. Alternatively, if forwarding the message is not desired, control continues to step S365 where the message is marked for deletion from the intended recipient's video mail box in the video mail server 300. In other alternative embodiments, the forwarding process may occur at other times in the process.

In step S370, it is determined whether the client wishes to retrieve the same message or another message. If the client wishes to retrieve the same message or a different message, control continues to and repeats step S340. Alternatively, if the client wants to end the access to the video mail server 300, control continues to step S375 to delete any messages marked for deletion and to step S380 to end the call.

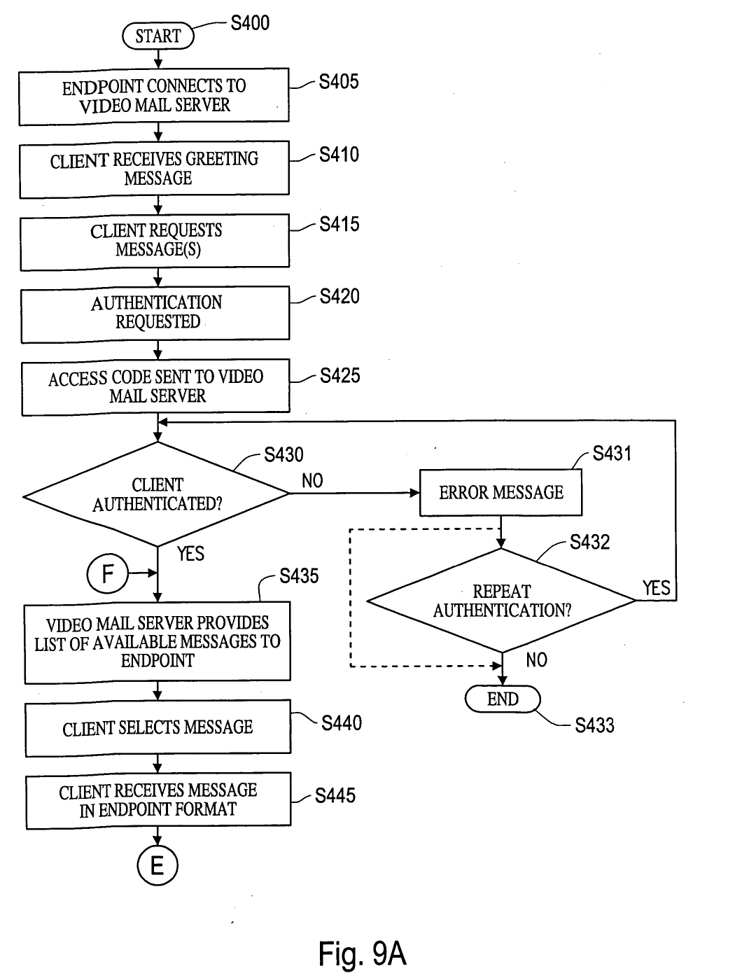

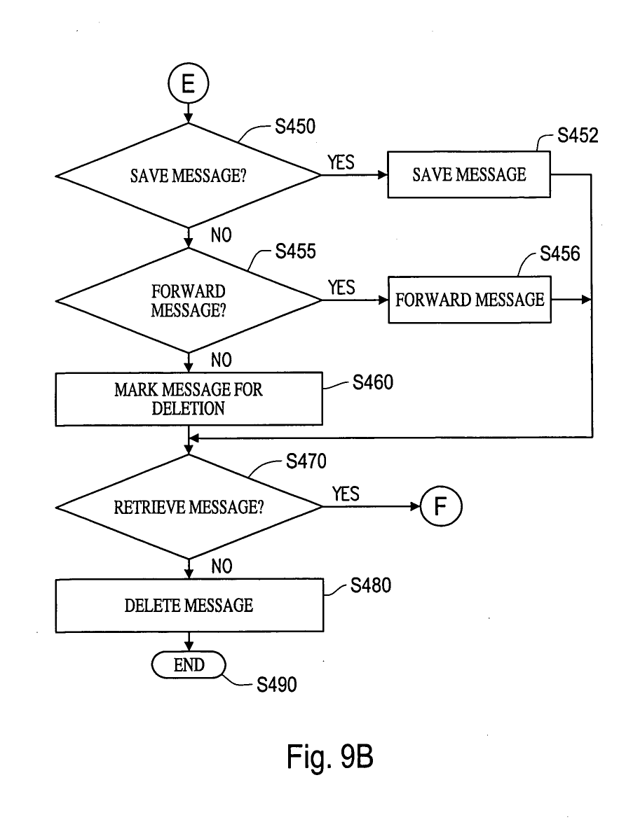

FIGS. 9A-9B are flowcharts illustrating an exemplary process according to this invention for retrieving the audio and video conference digital data streams (message) from the remote server when the intended recipient of the call (client) requests access to the message through an end point.

From the start in step S400, control continues to step S405 where the end point 310 connects to a video mail server 300. Control continues to step S410 where the client receives a greeting message.

Also in steps 410, the end point 310 can display a personal web page where the client can set up e-mail notifications for new messages, set a media player preference, forward video messages to other users, and replay messages. Also, through the personal web page, the client can access an address book to identify other Internet Protocol address. Further, the personal web page may notify the user of any messages which are near expiration and when the client's video mailbox is full or almost full.

In response to the greeting message, the client can request his or her messages in step S415.

After the client requests messages, the video mail server 300 requests authentication in step S420. In response, in step S425, the client sends an access code or other type of authentication to the video mail server 300 through end point 310, and control continues to step S430. Many systems can be used to authenticate the client including token based authentication, HTTP basic, Microsoft® active directory, lightweight directory access protocol (LDAP), or any other authentication system either existing or yet to be invented.

In other embodiments, the authentication process may occur at other times in the flowchart, such as at or about the time the computing device is connected to the video mail server, before the client receives the greeting message, etc.

Once the access code is sent to the video mail server 300, control continues to step 430 to determine whether the client's access has been authenticated. If the client's access is not authenticated, the end point receives and displays an error message in step S431. At that time, the process may end in step S433 as shown by the dotted line in FIG. 9A. Alternatively, the process may provide one or more opportunities for the client to send the proper access code to the video mail server 300. In this alternative, after the error message is displayed in step S431, control continues to step S432 which determines whether authentication should be repeated. If authentication is to be repeated, control continues to step S430. However, if access has been denied a predetermined number of times, for example three times, control continues from step S432 to step S433 and access to messages is denied.

If the client's access is authenticated, control continues to step S435, where the video mail server provides a list of available messages, which are stored in video mail server 300, to end point 310. In step S435, end point 310 displays a menu of available messages including new messages and possibly saved messages. In step S440, the client selects a message to be retrieved, and in step S445, the client receives a message in an end point format. While using the end point 310, the client can also perform operations on the message, including but not limited to fast forward, rewind, seek, scan, play, pause and stop. A known or yet to be invented web browser can be integrated into the end point 310 to perform these various operations. After the message has been received, control continues to step S450.

In step S450, the client has the option of saving the message in the video mail box of the video mail server 300. If the client decides to save the message, control continues to step S452 to save the message in the video mail box in video mail server 300. Alternatively, if the message is not saved, control continues to step S455. In alternative embodiments, the saving process can occur at other times in the flowchart.

In step S455, the client has the option of forwarding the message to another client who has a video mail box on the video mail server 300. If the client decides to forward the message to another client's video mailbox in video mail server 300, control continues to step S456 to forward the message to the other client's video mailbox in video mail server 300. Alternatively, if the message is not forwarded, control continues to step S460 where the message is marked for deletion from the intended recipient's video mailbox in the video mail server 300. In alternative embodiments, the forwarding process can occur at other times in the flowchart.

In step S470, it is determined whether the client wishes to retrieve the same message or another message. If the client wishes to retrieve the same message or a different message, control continues to step S435. Alternatively, if the client wishes to end the access to the video mail server 300, control continues to step S480 to delete any messages marked for deletion and to step S490 to end the call.

While this invention has been described in conjunction with the exemplary embodiments outlined above, various alternatives, modifications, variations, improvements, and/or substantial equivalents, whether known or that are or may be presently unforeseen, may become apparent upon reviewing the foregoing disclosure. Accordingly, the exemplary embodiments of the invention, as set forth above, are intended to be illustrative, not limiting. Various changes may be made without departing from the spirit and scope of the invention.

1. A method for transmitting a message from a calling device to a remote video mail server and for retrieving the message by a communication device at a later time over a distributed network, comprising:
connecting the calling device to the remote video mail server;
supplying the message from the calling device to the remote video mail server;
storing the message on the remote video mail server; and
accessing the message by the communication device from the remote video mail server at a later time.

2. The method of claim 1, wherein the calling device is one of an end point and an internet protocol phone.

3. The method of claim 1, wherein the communication device is one of an end point, a computing device, and an internet protocol phone.

4. The method of claim 3, wherein the computing device is one of a personal computer, a wireless computer, and a personal digital assistant.

5. The method of claim 1, wherein the message comprises a video data stream.

6. The method of claim 1, wherein the message comprises a video and audio data stream.

7. The method of claim 1, wherein the step of accessing the message from the remote video mail server though a communication device at a later time further comprises:
supplying a list of at least one message from the remote video mail server to the communication device;
selecting one of the messages from the list of at least one message using the communication device; and
supplying the selected one of the messages from the remote video mail server to the communication device.

8. The method as in claim 7, wherein the communication device has a display and at least one media player for displaying messages.

9. The method of claim 8, wherein the step of supplying the selected message from the remote video mail server to the communication device further comprises converting the stored message into a format which can be read by the at least one media player for displaying messages.

10. The method as in claim 1, wherein the communication device has a display and at least one media player for displaying messages.

11. The method as in claim 10, further comprising:
supplying a list of at least one message from the remote video mail server to the communication device;
selecting one of the messages from the list of at least one message using the communication device;
displaying the at least one media player; and
selecting one media player from the at least one media players for displaying the selected message.

12. The method of claim 11, wherein the step of selecting one media player further comprises converting the stored message into a format which can be read by the at least one media player for displaying messages.

13. The method of claim 1, wherein the message is stored in the video mail server in its original format.

14. The method of claim 1, wherein the message is stored in the video mail server in the H.323 standard format.

15. The method of claim 1, wherein the video mail server communicates with a gatekeeper.

16. The method of claim 1, wherein the step of accessing the message from the remote video mail server though a communication device at a later time further comprises a step of authenticating access to the message.

17. The method of claim 1, further comprising notifying at least one intended recipient of the message stored in the video mail server.

18. The method of claim 1, wherein the message is in a MP3 format.

19. The method of claim 1, wherein the message is in a compressed format.

20. The method of claim 1, wherein the calling device is connected to the video mail server through a multi-point control unit.

21. A system for transmitting a digital audio data stream and a digital video data stream as a message over a distributed network and for retrieving the message at a later time, comprising:
a calling device outputting the digital audio data stream and digital video data stream as the message to the distributed network;
a remote video mail server connectable to the distributed network to receive and store the message and permitting access to the message for later viewing; and
a communication device communicating with the remote server to access the message.

22. The system of claim 21, wherein the calling device is an internet protocol phone.

23. The system of claim 21, wherein the calling device is an end point.

24. The system of claim 23, wherein the end point is coupled to a video conference.

25. The system of claim 21, wherein the communication device is one of an end point, a computing device, and an internet protocol phone.

26. The system of claim 25, wherein the computing device is one of a personal computer, a wireless computer, and a personal digital assistant.

27. The system of claim 25, wherein the communication device includes at least one media player.

28. The system of claim 21, wherein the remote video mail server is coupled to an internet protocol phone through an internet protocol public branch exchange.

29. The system of claim 21, wherein the remote video mail server communicates with a gatekeeper.

30. The system of claim 21, wherein the remote video mail server includes a gatekeeper.

31. The system of claim 21, wherein the remote video mail server contains a storage unit which stores messages in video mail boxes.

32. The system of claim 21 wherein:
the communication device includes a display and a media player for displaying the message on the display;
the communication device requests the message in a media format, which can be accessed by the media player;
the remote video mail server converts the stored message into the media format and transmits the message in the media format to the communication device; and
the media player of the communication device reads the media format and displays the message on the display.

33. The system of claim 21 wherein:
the communication device includes a display and a media player for displaying the message on the display;
the remote video mail server supplies a list of at least one message to the communication device; and
the communication device enables selection of one of the at least one message and forwards the selected message to the remote video mail server.

34. The system of claim 33 wherein:
the remote video mail server converts the stored message into a media format and transmits the message in the media format to the communication device; and
the media player of the communication device reads the media format and displays the message on the display.

35. The system of claim 33 wherein:
the communication device displays the at least one media player;
the communication device enables selecting one media player from the at least one media player for displaying the message;
the communication device forwards the selection of the media player to the remote video mail server;
the remote video mail server converts the stored message into the selected format which can be read by the selected at least one media player for displaying messages;
the remote video mail server forwards the message in the selected format to the communication device; and
the media player of the communication device reads the media format and displays the message on the display.

36. The system of claim 21, wherein the message is stored in the video mail server in its original format.

37. The system of claim 21, wherein the message is stored in the video mail server in H.323 standard format.

38. The system of claim 21, wherein the remote video mail server notifies the intended recipient of the message stored in the video mail server.

39. The system of claim 21, wherein the message is in MP3 format.

40. The system of claim 21, wherein the message is in a compressed format.

41. The system of claim 21, wherein the distributed network is the Internet.

42. The system of claim 21, wherein:
the remote video mail server requests authentication from the communication device; and
the communication device forwards the authentication.

43. The system of claim 21, further comprising a multi-point control unit communicating with at least one calling device and the video mail server.
